(19) United States
(12) Patent Application Publication
(10) Pub. No.: US 2007/0114991 A1
(43) Pub. Date: May 24, 2007

(54) Magnetic detection device

(75) Inventors: Yoshinori Tatenuma, Tokyo (JP); Masahiro Yokotani, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/377,292

(22) Filed: Mar. 17, 2006

(30) Foreign Application Priority Data
Nov. 22, 2005 (JP) P2005-337117

(51) Int. Cl. G01B 7/30; G01B 7/14

(52) U.S. Cl. 324/207.25; 324/207.24

(57) ABSTRACT

A magnetic detection device includes a magnetic moving unit, a magnet that is arranged to face the magnetic moving unit and that applies a magnetic field to the magnetic moving unit, and a magnetoelectric conversion element that is arranged to face the magnetic moving unit and includes at least one segment that detects a change in the applied magnetic field due to rotation of the magnetic moving unit, wherein the magnetic moving unit has a shape that generates an asymmetrical change in magnetic field to the magnetoelectric conversion element in accordance with the direction of rotation of the magnetic moving unit. Thus, a magnetic detection device that can detect the direction of rotation easily and reliably is provided.

### BACKGROUND OF THE INVENTION

1. Field of the Invention

This invention relates to a magnetic detection device using a magnetoresistance element (hereinafter referred to as MR element), which is a magnetoelectric conversion element.

2. Description of the Related Art

In conventional magnetic detection devices, a bridge circuit is formed by forming an electrode at each end of a magnetoresistance segment that constitutes an MR element, with a constant-voltage and constant-current power source connected between the two counter-electrodes of the bridge circuit, and a change in the resistance value of the MR element due to rotation of a magnetic moving unit is converted to a voltage change, thus detecting a change in the magnetic field acting on the MR element, for example, as disclosed in JP-A-2002-90181 and JP-A-2005-156368.

In the magnetic detection device disclosed in JP-A-2002-90181, rugged cogs formed on the circumferential edge of the magnetic moving unit are symmetrical about the cog center. Therefore, even when the magnetic moving unit is reversed, a change in the applied magnetic field similar to the change in the applied magnetic field in the case of normal rotation occurs in the MR element, and the same final output signal is generated irrespective of the direction of rotation of the magnetic moving unit. Therefore, the direction of rotation cannot be detected.

In the magnetic detection device disclosed in JP-A-2005-156368, it is possible to detect the direction of rotation of the magnetic moving unit. However, since it uses the magnetic moving unit in which the rugged cogs are symmetrical about the cog center, plural magnetoresistance segments must be arranged in a complex pattern in order to detect the direction of rotation of the magnetic moving unit. Therefore, the device is complicated and expensive.

### SUMMARY OF THE INVENTION

In view of the foregoing circumstances, it is an object of this invention to provide a magnetic detection device that can detect the direction of rotation easily and reliably.

A magnetic detection device according to an aspect of this invention includes a magnetic moving unit, a magnet that is arranged to face the magnetic moving unit and that applies a magnetic field to the magnetic moving unit, and a magnetoelectric conversion element including at least one segment that is arranged to face the magnetic moving unit and that detects a change in the applied magnetic field due to rotation of the magnetic moving unit, wherein the magnetic moving unit has a shape that generates an asymmetrical change in magnetic field to the magnetoelectric conversion element in accordance with the direction of rotation of the magnetic moving unit.

Since the magnetic detection device according to an aspect of this invention uses the magnetic moving unit having a shape that generates an asymmetrical change in magnetic field to the magnetoelectric conversion element in accordance with the direction of rotation, the magnetic detection device can detect the direction of rotation of the magnetic moving unit easily and reliably.

### BRIEF DESCRIPTION OF THE DRAWINGS

FIGS. 1A and 1B are perspective view and top view of essential parts showing the construction of a magnetic detection device according to Embodiment 1 of this invention.

FIG. 2 is a top view showing the shape of a magnetoresistance segment in Embodiment 1.

FIG. 3 shows the construction of a processing circuit part of the magnetic detection device according to Embodiment 1.

FIGS. 4A to 4D are timing charts showing the operation (in normal rotation) of the magnetic detection device according to Embodiment 1.

FIGS. 5A to 5D are timing charts showing the operation (in reverse rotation) of the magnetic detection device according to Embodiment 1.

FIGS. 6A and 6B are perspective view and top view of essential parts showing the construction of a magnetic detection device according to Embodiment 2 of this invention.

FIGS. 7A to 7D are timing charts showing the operation (in normal rotation) of the magnetic detection device according to Embodiment 2.

FIGS. 8A to 8D are timing charts showing the operation (in reverse rotation) of the magnetic detection device according to Embodiment 2.

### DETAILED DESCRIPTION OF THE PREFERRED EMBODIMENTS

### Embodiment 1

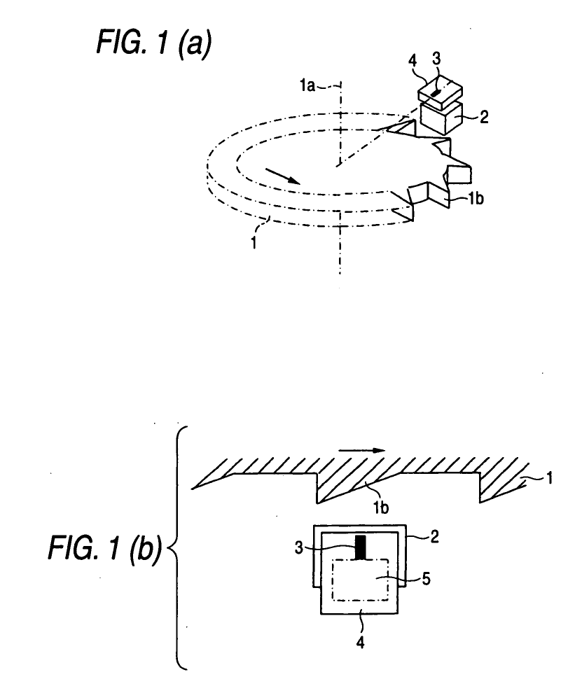

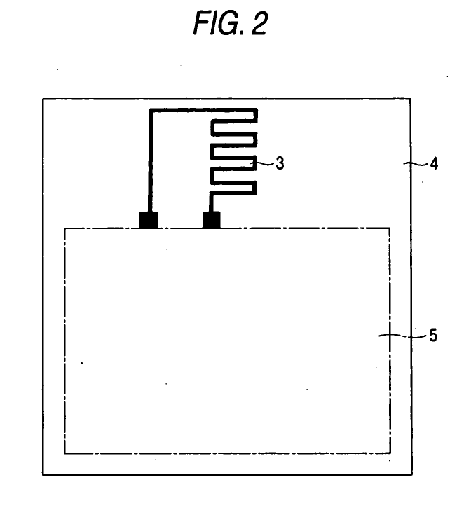

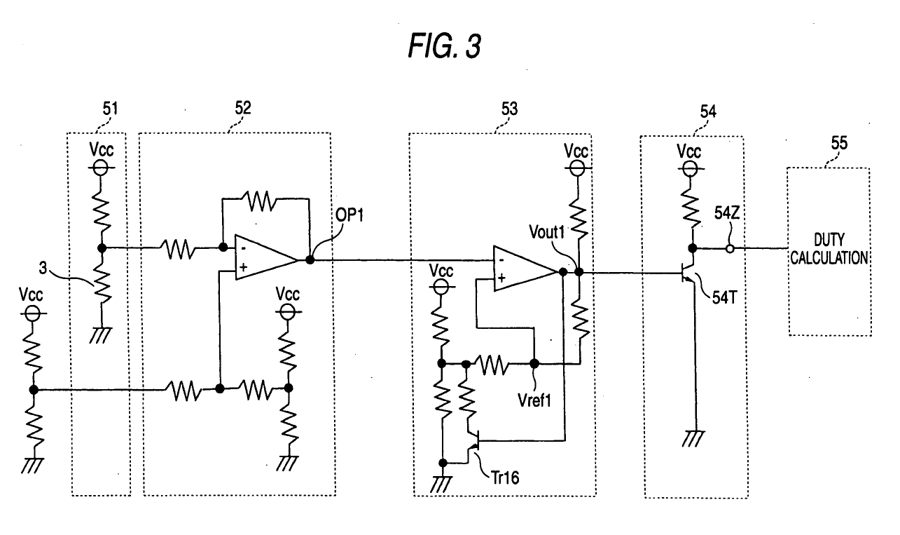

FIGS. 1A and 1B to FIG. 3 are structural views showing a magnetic detection device according to Embodiment 1. FIG. 1A is a perspective view. FIG. 1B is a top view of essential parts. FIG. 2 shows a pattern of a magnetoresistance segment that constitutes an MR element. FIG. 3 is a circuit structural view of a signal processing circuit part.

In this magnetic detection device, a magnetic moving unit 1 is coupled with a detection subject and rotates normally (in the direction of the arrow in FIG. 1A) or in reverse about a rotation axis 1a. A magnet 2 is arranged to face an outer circumferential part of the magnetic moving unit 1 in order to apply a magnetic field to the magnetic moving unit 1. On the top of the magnet 2, a board 4 is arranged on which a magnetoresistance segment that constitutes an MR element 3 is formed. Moreover, a processing circuit part 5 is printed on the board 4. Thus, a construction to detect a change in magnetic field due to rotation of the magnetic moving unit 1 is provided.

Here, the magnetic moving unit 1 has plural serration-like protrusions 1b formed on its circumferential edge. Each serration-like protrusion 1b has a shape with its height gradually reduced along the direction of normal rotation of the magnetic moving unit 1 (direction of the arrow) in order to be asymmetrical to the MR element 3. However, the shape of the serration-like protrusion 1b is not limited to the above shape. It may have any shape with its height gradually reduced along the direction of rotation of the magnetic moving unit 1.

While the MR element 3 is illustrated as one black block in FIGS. 1A and 1B, the MR element 3 is formed by a magnetoresistance segment having a shape as shown in FIG. 2.

FIG. 3 shows the construction of the processing circuit part 5 of the magnetic detection device in Embodiment 1.

In FIG. 3, a constant voltage VCC is applied to a bridge circuit 51 formed by the MR element 3 and fixed resistance, and the bridge circuit 51 converts a change in resistance value of the MR element 3 due to a change in magnetic field to a voltage change. The signal, converted to the voltage change, is amplified by a differential amplifier circuit 52 and inputted to a comparator circuit 53. The signal compared with a predetermined voltage by the comparator circuit 53 is converted to an output of “0” or “1” (=VCC) by a transistor 54T of an output circuit 54 and then outputted from an output terminal 54Z. Then, a normal/reverse rotation judging circuit 55 calculates the duty of the output acquired from the output terminal 54Z and judges whether the rotation is normal or reverse on the basis of the result of the calculation.

Now, the operation of the magnetic detection device according to Embodiment 1 will be described with reference to the drawings.

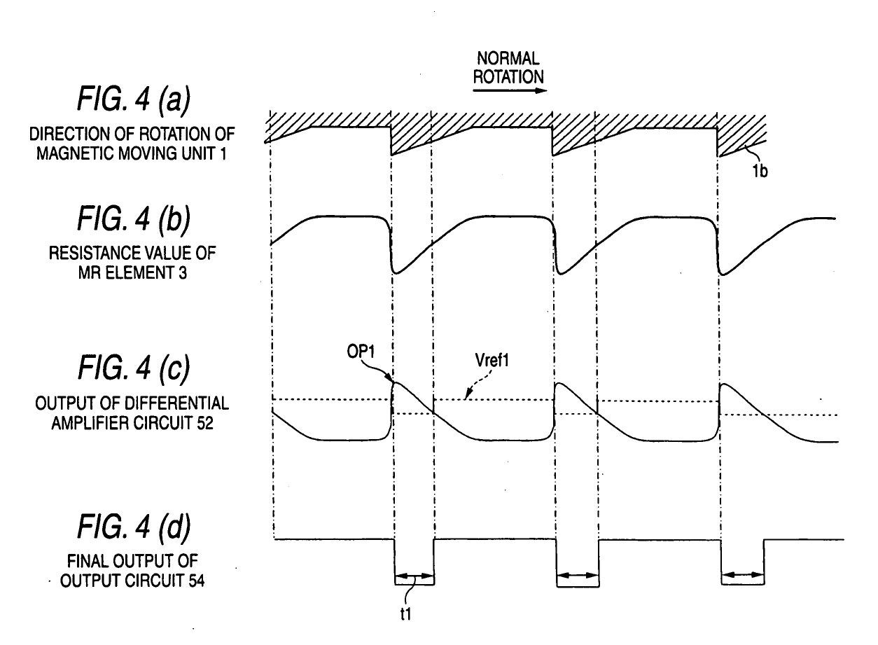

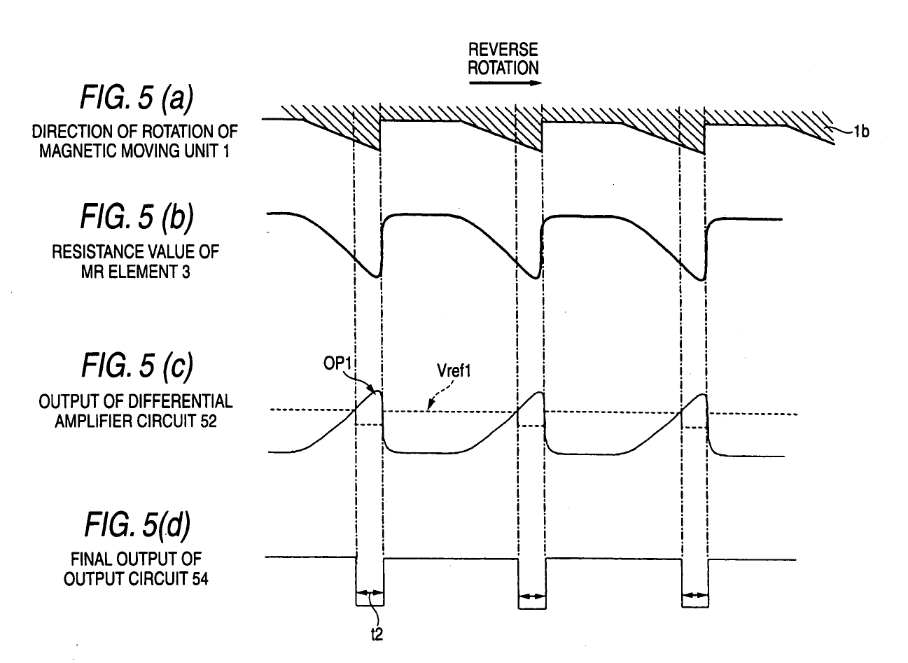

FIGS. 4A to 4D and FIGS. 5A to 5D are timing charts showing the operations of the magnetic detection device in the normal rotation and the reverse rotation of the magnetic moving unit 1. FIGS. 4A and 5A show the rotation state of the magnetic moving unit 1. FIGS. 4B and 5B show the resistance value of the MR element 3. FIGS. 4C and 5C show the output of the differential amplifier circuit 52. FIGS. 4D and 5D show the change in the output of the output circuit 54.

In Figs. 1A and 1B, when the magnetic moving unit 1 rotates normally, the applied magnetic field to the MR element 3 is changed by the serration-like protrusions 1b. The resistance value of the MR element 3 changes in accordance with the shape of the magnetic moving unit 1, as shown in FIGS. 4A and 4B, and an output OP1 of the differential amplifier circuit 52 as shown in FIG. 4C is provided.

The output OP1 of the differential amplifier circuit 52 is compared with a reference value Vref1 by the comparator circuit 53, thus shaping the waveform and providing an output signal “1” or “0” corresponding to the shape of the magnetic moving unit 1 as an output of the output circuit 54, as shown in FIG. 4D.

In the case of normal rotation, the period during which the output signal is “1” is represented by t1, as shown in FIG. 4D.

Next, the operation in the case of reverse rotation is shown in FIGS. 5A to 5D. When the magnetic moving unit 1 rotates in reverse, the applied magnetic field to the MR element 3 is changed by the serration-like protrusions 1b. The resistance value of the MR element 3 changes in accordance with the shape of the magnetic moving unit 1, as shown in FIGS. 5A and 5B, and an output OP1 of the differential amplifier circuit 52 as shown in FIG. 5C is provided.

The output OP1 of the differential amplifier circuit 52 is compared with a reference value Vref1 by the comparator circuit 53, thus shaping the waveform and providing an output signal “1” or “0” corresponding to the shape of the magnetic moving unit 1 as an output of the output circuit 54, as shown in FIG. 5D.

In the case of reverse rotation, the period during which the output signal is “1” is represented by t2, as shown in FIG. 5D.

Thus, as seen from FIGS. 4D and 5D, the relation between the two periods during which the output signal of the output circuit 54 is “1” is t1>t2. The length of the period differs between normal rotation and reverse rotation.

The normal/reverse rotation judging circuit 55 calculates the duty of each of t1 and t2. For example, by judging that the rotation is normal when the duty is 60% and judging that the rotation is reverse when the duty is 80%, it is possible to detect whether the direction of rotation is normal or reverse.

As described above, the magnetic detection device according to Embodiment 1 uses the magnetic moving unit 1 having the shape that generates an asymmetrical change in magnetic field to the MR element 3 in accordance with the direction of rotation, and can detect the direction of rotation of the magnetic moving unit 1 easily and reliably.

Also, since the magnetic moving unit 1 has the simple shape in which the serration-like protrusions 1b with their height gradually changed along the direction of rotation are formed on the circumferential edge, the magnetic moving unit 1 can be constructed inexpensively.

### Embodiment 2

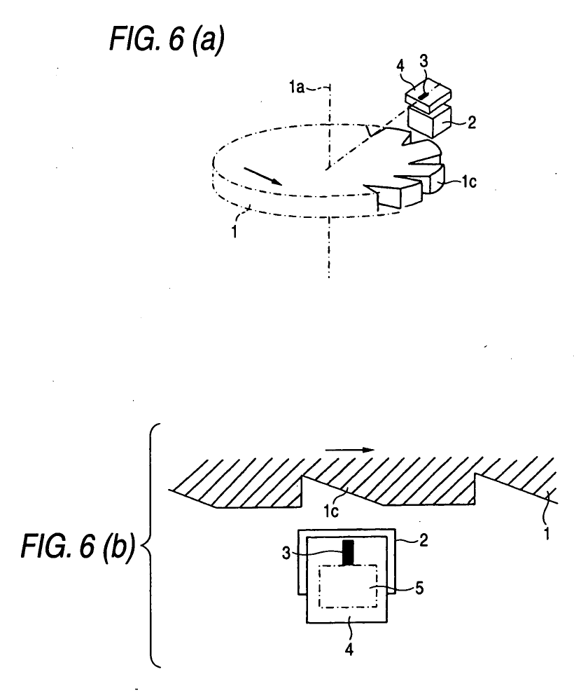

FIGS. 6A and 6B to FIGS. 8A to 8D are structural views showing a magnetic detection device according to Embodiment 2.

FIG. 6A is a perspective view. FIG. 6B is a top view of essential parts.

This magnetic detection device according to Embodiment 2 has basically the same construction as the magnetic detection device of Embodiment 1. However, in this magnetic detection device, the magnetic moving unit 1 has plural serration-like recesses 1c formed on its circumferential edge. Each serration-like recess 1c has a shape with its depth gradually reduced along the direction of normal rotation of the magnetic moving unit 1 in order to be asymmetrical to the MR element 3. However, the shape of the serration-like recess 1c is not limited to the above shape. It may have any shape with its depth gradually reduced along the direction of rotation of the magnetic moving unit 1.

The processing circuit part 5 of the magnetic detection device in Embodiment 2 is the same as the processing circuit part in Embodiment 1 shown in FIG. 3 and therefore will not be described further in detail. However, in the bridge circuit 51 formed by the MR element 3 and fixed resistance, the vertical positional relation of the MR element 3 and the fixed resistance is opposite to the positional relation in Embodiment 1.

Now, the operation of the magnetic detection device according to Embodiment 2 will be described with reference to the drawings.

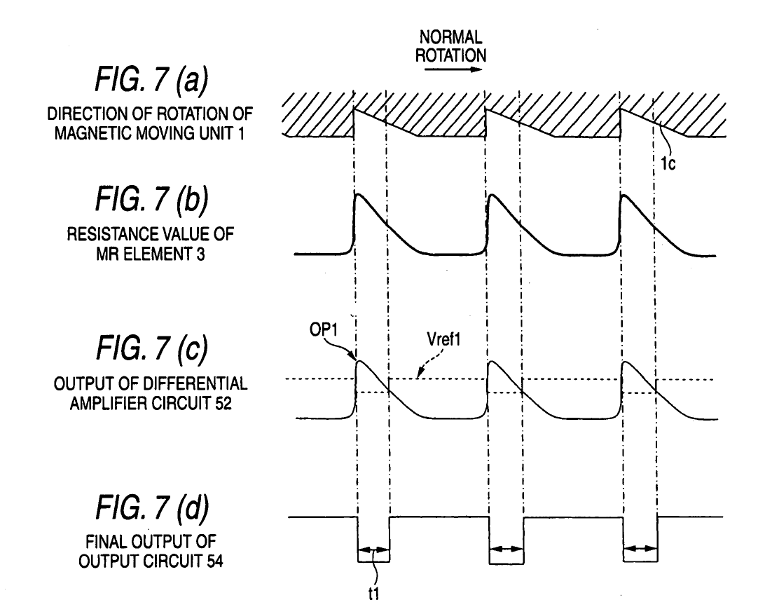

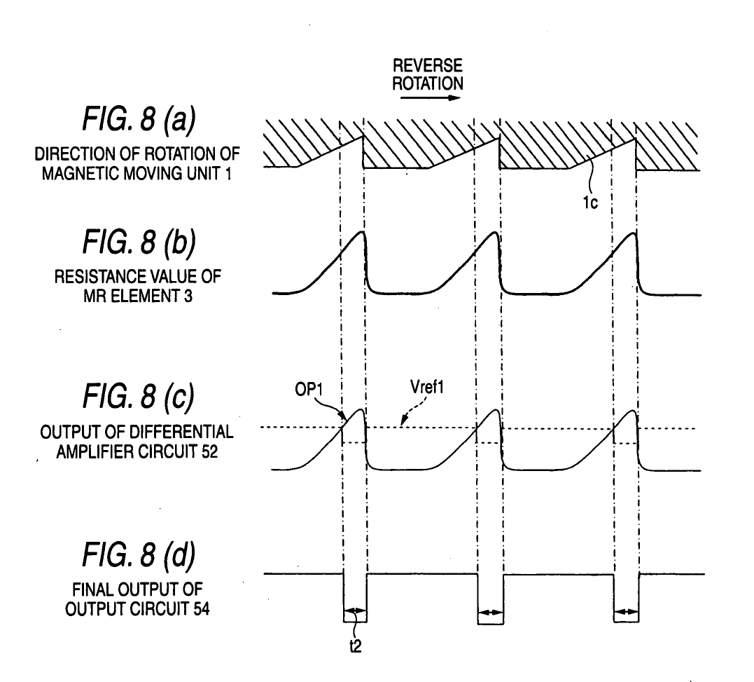

FIGS. 7A to 7D and FIGS. 8A to 8D are timing charts showing the operations of the magnetic detection device in the normal rotation and the reverse rotation of the magnetic moving unit 1. FIGS. 7A and 8A show the rotation state of the magnetic moving unit 1. FIGS. 7B and 8B show the resistance value of the MR element 3. FIGS. 7C and 8C show the output of the differential amplifier circuit 52. FIGS. 7D and 8D show the change in the final output of the output circuit 54.

In FIGS. 6A and 6B, when the magnetic moving unit 1 rotates normally, the applied magnetic field to the MR element 3 is changed by the serration-like recesses 1c. The resistance value of the MR element 3 changes in accordance with the shape of the magnetic moving unit 1, as shown in FIGS. 7A and 7B, and an output OP1 of the differential amplifier circuit 52 as shown in FIG. 7C is provided.

The output OP1 of the differential amplifier circuit 52 is compared with a reference value Vref1 by the comparator circuit 53, thus shaping the waveform and providing a final output signal “1” or “0” corresponding to the shape of the magnetic moving unit 1 as a final output of the output circuit 54, as shown in FIG. 7D.

In the case of normal rotation, the period during which the final output signal is “1” is represented by t1, as shown in FIG. 7D.

Next, the operation in the case of reverse rotation is shown in FIGS. 8A to 8D. When the magnetic moving unit 1 rotates in reverse, the applied magnetic field to the MR element 3 is changed by the serration-like recesses 1c. The resistance value of the MR element 3 changes in accordance with the shape of the magnetic moving unit 1, as shown in FIGS. 8A and 8B, and an output OP1 of the differential amplifier circuit 52 as shown in FIG. 8C is provided.

The output OP1 of the differential amplifier circuit 52 is compared with a reference value Vref1 by the comparator circuit 53, thus shaping the waveform and providing a final output signal “1” or “0” corresponding to the shape of the magnetic moving unit 1 as a final output of the output circuit 54, as shown in FIG. 8D.

In the case of reverse rotation, the period during which the final output signal is “1” is represented by t2, as shown in FIG. 8D.

Thus, as seen from FIGS. 7D and 8D, the relation between the two periods during which the final output signal of the output circuit 54 is “1” is t1>t2. The length of the period differs between normal rotation and reverse rotation.

The normal/reverse rotation judging circuit 55 calculates the duty of each of t1 and t2. For example, by judging that the rotation is normal when the duty is 60% and judging that the rotation is reverse when the duty is 80%, it is possible to detect whether the direction of rotation is normal or reverse.

As described above, the magnetic detection device according to Embodiment 2 has the simple construction using the magnetic moving unit 1 having the shape that generates an asymmetrical change in magnetic field to the MR element 3 in accordance with the direction of rotation, and can detect the direction of rotation of the magnetic moving unit 1 easily and reliably.

Also, since the magnetic moving unit 1 has the simple shape in which the serration-like recesses 1c with their depth gradually changed along the direction of rotation are formed on the circumferential edge, the magnetic moving unit 1 can be constructed inexpensively.

1. A magnetic detection device comprising:
a magnetic moving unit,
a magnet that is arranged to face the magnetic moving unit and that applies a magnetic field to the magnetic moving unit,
a magnetoelectric conversion element that is arranged to face the magnetic moving unit and that includes at least one segment that detects a change in the applied magnetic field due to rotation of the magnetic moving unit, and
a processing circuit part that is coupled to the magnetoelectric conversion element and that detects a direction of rotation of the magnetic moving unit,
wherein the magnetic moving unit has serration-like protrusions on its circumferential edge, the serration-like protrusions each having a uniform shape, and having their height gradually changed along the direction of rotation,
wherein the processing circuit part comprises a rotation judging circuit that calculates a duty cycle of an acquired output and judges on the basis of the duty cycle calculation whether the rotation of the magnetic moving unit is normal or reverse.

2. A magnetic detection device comprising:
a magnetic moving unit,
a magnet that is arranged to face the magnetic moving unit and that applies a magnetic field to the magnetic moving unit.
a magnetoelectric conversion element that is arranged to face the magnetic moving unit and that includes at least one segment that detects a change in the applied magnetic field due to rotation of the magnetic moving unit, and a processing circuit part that is coupled to the magnetoelectric conversion element and that detects a direction of rotation of the magnetic moving unit,
wherein the magnetic moving unit has serration-like recesses on its circumferential edge, the serration-like recesses each having a uniform shape, and having their depth gradually changed along the direction of rotation.
wherein the processing circuit part comprises a rotation judging circuit that calculates a duty cycle of an acquired output and judges on the basis of the duty cycle calculation whether the rotation of the magnetic moving unit is normal or reverse.

3. (canceled)

4. The magnetic detection device as claimed in claim 1, wherein the processing circuit part further comprises a bridge circuit formed by the magnetoelectric conversion element and a fixed resistance.

5. The magnetic detection device as claimed in claim 1, wherein the magnetoelectric conversion element is configured in the form of a comb shape.

6. The magnetic detection device as claimed in claim 1, wherein a bridge circuit converts a change in resistance value of the magnetoelectric conversion element to a voltage change, and the processing circuit part further comprises:
a differential amplifier circuit that amplifies a signal representing the voltage change output from the bridge circuit,
a comparator circuit that compares the amplified signal with a predetermined voltage to yield a comparison result, and
an output circuit that converts the comparison result into the acquired output.

7. The magnetic detection device of claim 1, wherein the serration-like protrusions each have edges having different lengths.

8. The magnetic detection device of claim 7, wherein the serration-like protrusions are regularly spaced on the circumferential edge.

9. The magnetic detection device of claim 2, wherein the serration-like recesses each have at least two edges and wherein said at least two edges have different lengths.

10. The magnetic detection device of claim 9, wherein the serration-like recesses are regularly spaced on the circumferential edge.
